(19) United States
(12) Patent Application Publication
(10) Pub. No.: US 2008/0289725 A1
(43) Pub. Date: Nov. 27, 2008

(54) Manufacturing Method of Magnetic Tip of Tape Measure

(76) Inventor: Huei-Yen LIAO, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/753,702

(22) Filed: May 25, 2007

(51) Int. Cl. B22D 19/00; B29C 39/10; H01F 13/00

(52) U.S. Cl. 148/103; 164/112; 264/349

(57) ABSTRACT

A manufacturing method of magnetic tip of tape measure comprising: first step which is preparing a conducting magnet material which is still not magnetized; second step which is setting said conducting magnet material into a die; third step which is casting a form material to produce a tip of tape measure structure and making said form material to combine with said conducting magnet material; fourth step which is magnetizing said conducting magnet material and manufacturing a magnetic tip of tape measure.

### BACKGROUND OF THE INVENTION

1. Field of the Invention

The present invention relates to a manufacturing method of a tip of tape measure and more specifically to a manufacturing method of a magnetic tip of tape measure.

2. Description of the Related Art

Disclosed in Taiwanese Patent I276777 is a tip portion comprising a tip 40 forming two apertures 48a, 48b, the apertures is provided for receiving two magnets 60a, 60b. And a frame 50 which has a slot riveting to the tip 40. However, an install portion 30 and the tip 40 are shaped in the mold via continuously pressing and cold work. And the step for installing the magnets 60a, 60b and the frame 50 is further needed to proceed. The manufacturing method would take a lot of time and waste the cost.

Disclosed in Taiwanese Patent M275402 is a tip portion 1 including a tip 3 forming a recess 31, a magnet 4 provided for received in the recess 31 and the magnet 4 attaching to the recess 31 by agglutinant. The tip portion 1 is also shaped in the mold via continuously pressing and cold work and the step for attaching the magnet 4 to the tip 3 is further needed to proceed. The manufacturing method would take a lot of time and waste the cost.

Disclosed in Taiwanese Patent M258275 is a L-shaped tip 20 including a plurality of position devices 22 provided for setting a magnetic device 40. The L-shaped tip is also shaped in the mold via continuously pressing and cold work and the step for installing the magnetic device 40 is further needed to proceed. The manufacturing method would take a lot of time and waste the cost. Disclosed in Taiwanese Patent M247817 is a tip 3 including a measure portion 33 with a stick device 34. The device 34 is beset on the measure portion 33 by pressing in the mold. The tip 3 is also shaped in the mold via continuously pressing and cold work and the step for attaching the device 34 on the tip 3 is further needed to proceed. The manufacturing method would take a lot of time and waste the cost. Moreover the combination strength between the tip and the magnet is not good so that the magnet is easy to fall off.

The present invention is therefore intended to obviate or at least alleviate the problems encountered in prior art.

### SUMMARY OF THE INVENTION

The present invention discloses a manufacturing method of magnetic tip of tape measure comprising the steps that follow. First step: preparing a conducting magnet material which is still not magnetized; second step: setting said conducting magnet material into a die; third step: casting a form material to produce a tip of tape measure structure and make the form material to combine with the conducting magnet material; fourth step: magnetizing the conducting magnet material which has combined with the form material and manufacture a magnetic tip of tape measure.

Other objectives, advantages, and features of the invention will become more apparent from the following detailed description when taken in conjunction with the accompanying drawings.

### BRIEF DESCRIPTION OF THE DRAWINGS

FIG. 1 is an illustration showing a flowchart of a manufacturing method of magnetic tip of tape measure in accordance with one embodiment of the present invention.

FIG. 2 is a pictorial drawing of the manufactured magnetic tip of tape measure in accordance with one embodiment of the present invention.

FIG. 3 is a cross sectional view of the manufactured magnetic tip of tape measure in accordance with one embodiment of the present invention.

FIG. 4 is a pictorial drawing of a tape measure with the manufactured magnetic tip in accordance with one embodiment of the present invention.

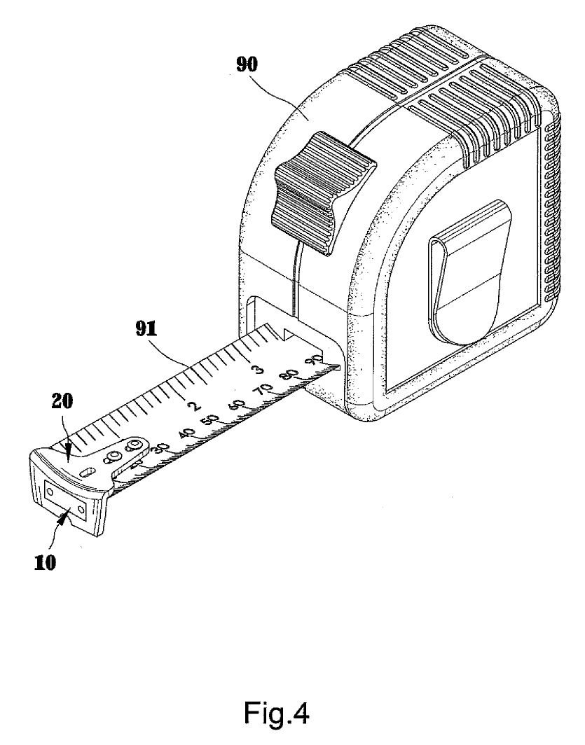

FIG. 5 is a cross sectional view of the manufactured magnetic tip of tape measure in accordance with another embodiment of the present invention.

FIG. 6 is a pictorial drawing of the manufactured magnetic tip of tape measure in accordance with another embodiment of the present invention.

FIG. 7 is an illustration showing a flowchart of a manufacturing method of magnetic tip of tape measure in accordance with another embodiment of the present invention.

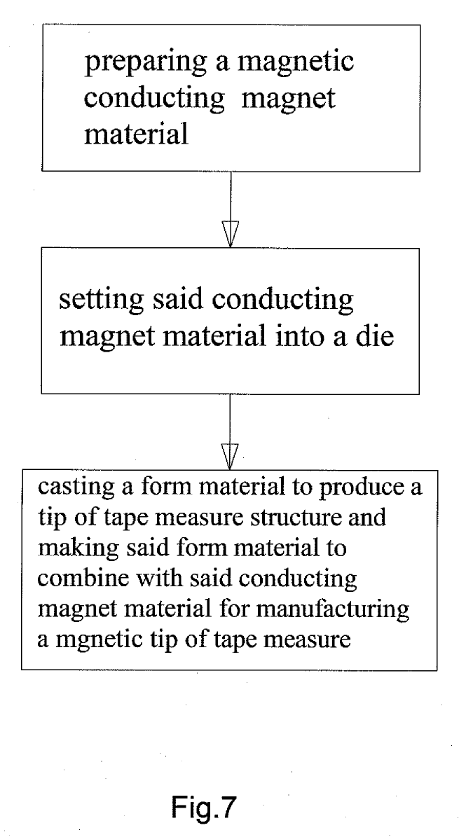

### DETAILED DESCRIPTION OF THE PREFERRED EMBODIMENT

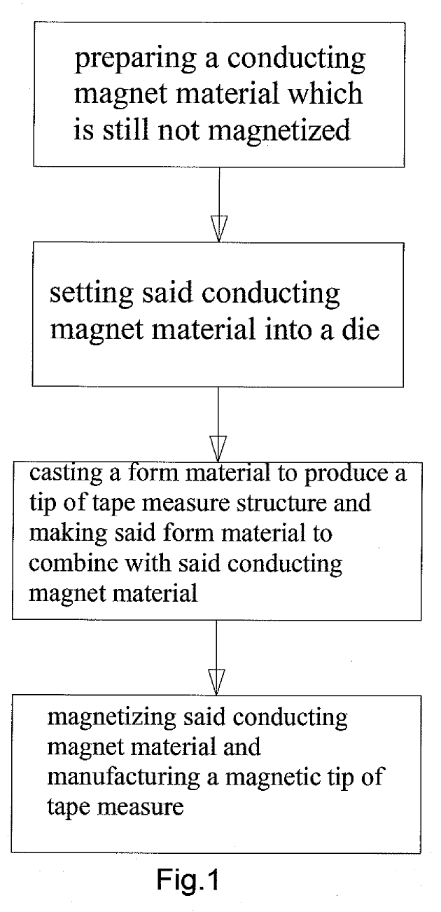

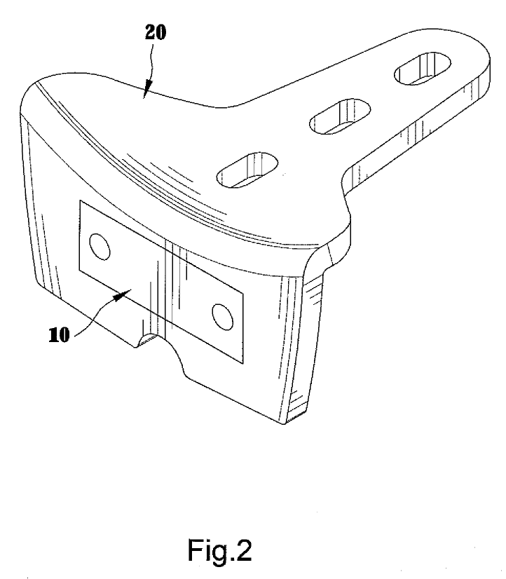

Referring to FIGS. 1 and 2, a manufacturing method of magnetic tip of tape measure in accordance with one embodiment of the present invention comprises first step: preparing a conducting magnet material 10 which is still not magnetized. The conducting magnet material 10 could be made from single metal or compound metal.

In this embodiment, the conducting magnet material 10 is preferably rectangle. However, the conducting magnet material 10 could be circular, triangle or any shape.

Second step: setting the conducting magnet material 10 into a die.

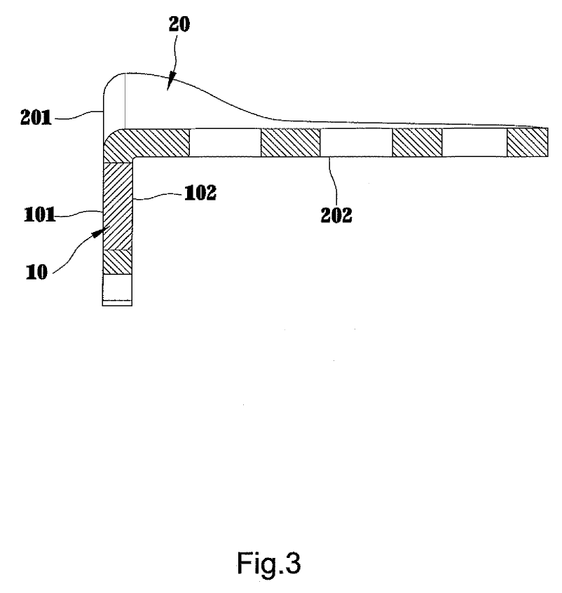

Third step: casting a form material 20 to produce a tip of tape measure structure. The form material 20, therefore, combines with the conducting magnet material 10 and a first and second portion 101,102 of the conducting magnet material 10 are exposed from the form material 20. Referring to FIG. 3, the first and second portions 101,102 respectively flush with a first and second side of the form material 20.

In this embodiment, the form material 20 forms the tip of tape measure structure via die-casting. The form material 20 is preferably light material like magnesium alloy, aluminum alloy and so forth.

Alternatively, the form material 20 forms the tip of tape measure structure via thixomolding while the form material 20 is made from magnesium alloy.

Alternatively, the form material 20 forms the tip of tape measure structure via injection molding. And the form material 20 is preferably plastic material.

Fourth step: magnetizing the conducting magnet material 10 which has combined with the form material 20. The conducting magnet material 10 is magnetized and a magnetic tip of tape measure is manufactured. The manufacturing method of magnetic tip of tape measure could save cost; moreover, because of well combination strength between the conducting magnet material 10 and the form material 20, the method could also increase use of life.

Apart from above, the form material 20, which forms the tip of tape measure structure via the manufacturing method of magnetic tip of tape measure, is light material such like magnesium alloy, aluminum alloy, plastic and so forth. And the advantage of the manufactured magnetic tip is further decreasing weight. Therefore, a tape 91 of a tape measure 90 is not easy to bend by gravity during extending from the tape measure 90.

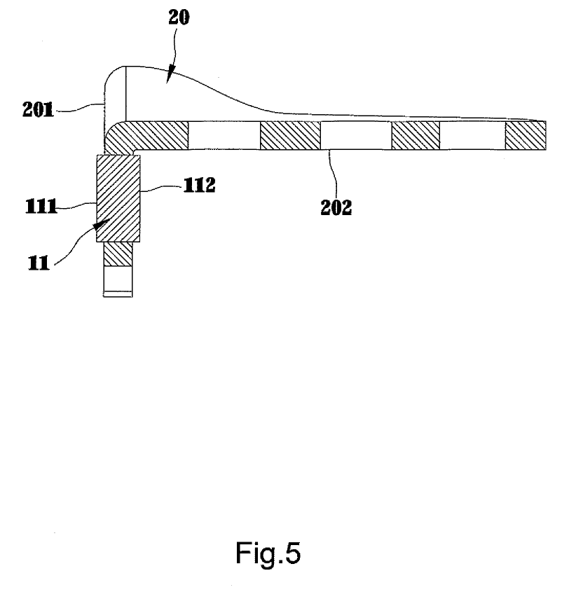

Referring to FIG. 5, it shows another embodiment of the present invention. In third step, to cast a form material 20 to produce a tip of tape measure structure. The form material 20, therefore, combines with a conducting magnet material 11 and a first and second portion 111,112 of the conducting magnet material 10 are exposed from the form material 20.

In this embodiment, the first and second portions 111,112 respectively protrude from the first and second side of the form material 20.

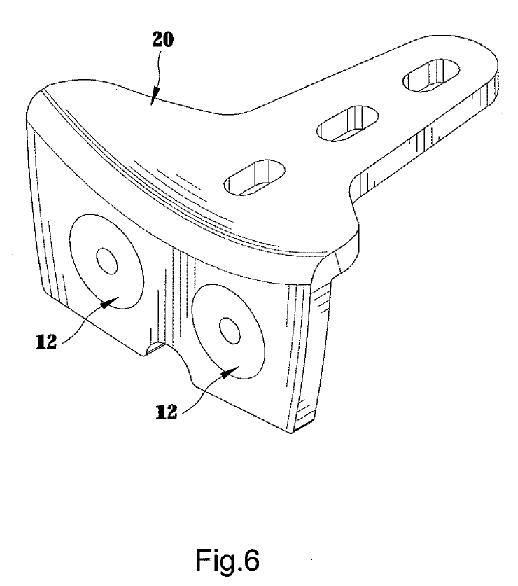

Referring to FIG. 6, it shows yet embodiment of the present invention. In first step, to prepare at least two conducting magnet materials 12 which are still not magnetized. The conducting magnet materials 12 are preferably circular in this embodiment. However, the conducting magnet materials 12 could be any shape.

Referring to FIG. 6, it shows still yet embodiment of the present invention. In first step, to prepare a magnetized conducting magnet material 10 so we can drop the fourth step (to magnetize the conducting magnet material). Therefore, the advantage of the modified method is simplifying the steps of produce and save time.

What is claimed is:

1. A manufacturing method of magnetic tip of tape measure comprising:
first step: preparing a magnetized conducting magnet material;
second step: setting said conducting magnet material into a die;
third step: casting a form material to produce a tip of tape measure structure and making said form material to combine with said conducting magnet material for manufacturing a magnetic tip of tape measure.

2. A manufacturing method of magnetic tip of tape measure as claimed in claim 1, wherein the conducting magnet material is single metal or an alloy of at least two kinds of metals.

3. A manufacturing method of magnetic tip of tape measure as claimed in claim 1, wherein first step which is preparing at least two conducting magnet material.

4. A manufacturing method of magnetic tip of tape measure as claimed in claim 1, wherein the conducting magnet material could be rectangle, circular, triangle or any shape.

5. A manufacturing method of magnetic tip of tape measure as claimed in claim 1, wherein a first and second portions of the conducting magnet material are exposed from the form material.

6. A manufacturing method of magnetic tip of tape measure as claimed in claim 5, wherein the first and second portions of the conducting magnet material respectively flush with a first and second sides of the form material.

7. A manufacturing method of magnetic tip of tape measure as claimed in claim 5, wherein the first and second portions of the conducting magnet material respectively protrude from with a first and second sides of the form material.

8. A manufacturing method of magnetic tip of tape measure as claimed in claim 1, wherein the form material is light material such like magnesium alloy, aluminum alloy and so forth.

9. A manufacturing method of magnetic tip of tape measure comprising:
first step preparing a conducting magnet material which is still not magnetized;
second step: setting said conducting magnet material into a die;
third step: casting a form material to produce a tip of tape measure structure and making said form material to combine with said conducting magnet material;
fourth step: magnetizing said conducting magnet material and manufacturing a magnetic tip of tape measure.

10. A manufacturing method of magnetic tip of tape measure as claimed in claim 9, wherein the conducting magnet material is single metal or an alloy of at least two kinds of metals.

11. A manufacturing method of magnetic tip of tape measure as claimed in claim 9, wherein first step which is preparing at least two conducting magnet material

12. A manufacturing method of magnetic tip of tape measure as claimed in claim 9, wherein the conducting magnet material could be rectangle, circular, triangle or any shape.

13. A manufacturing method of magnetic tip of tape measure as claimed in claim 9, wherein a first and second portions of the conducting magnet material are exposed from the form material.

14. A manufacturing method of magnetic tip of tape measure as claimed in claim 13, wherein the first and second portions of the conducting magnet material respectively flush with a first and second sides of the form material.

15. A manufacturing method of magnetic tip of tape measure as claimed in claim 13, wherein the first and second portions of the conducting magnet material respectively protrude from with a first and second sides of the form material.

16. A manufacturing method of magnetic tip of tape measure as claimed in claim 9, wherein the form material is light material such like magnesium alloy, aluminum alloy and so forth.

17. A manufacturing method of magnetic tip of tape measure comprising:
first step: preparing a magnetized conducting magnet material;
second step: setting said conducting magnet material into a mold;
third step: using a form material to produce a tip of tape measure structure via injection molding and making said form material to combine with said conducting magnet material for manufacturing a magnetic tip of tape measure.

18. A manufacturing method of magnetic tip of tape measure as claimed in claim 17, wherein the conducting magnet material is single metal or an alloy of at least two kinds of metals

19. A manufacturing method of magnetic tip of tape measure as claimed in claim 17, wherein first step which is preparing at least two conducting magnet material.

20. A manufacturing method of magnetic tip of tape measure as claimed in claim 17, wherein the conducting magnet material could be rectangle, circular, triangle or any shape.

21. A manufacturing method of magnetic tip of tape measure as claimed in claim 17, wherein a first and second portions of the conducting magnet material are exposed from the form material.

22. A manufacturing method of magnetic tip of tape measure as claimed in claim 21, wherein the first and second portions of the conducting magnet material respectively flush with a first and second sides of the form material.

23. A manufacturing method of magnetic tip of tape measure as claimed in claim 21, wherein the first and second portions of the conducting magnet material respectively protrude from with a first and second sides of the form material.

24. A manufacturing method of magnetic tip of tape measure as claimed in claim 17, wherein the form material is plastic material.

25. A manufacturing method of magnetic tip of tape measure comprising:
first step: preparing a conducting magnet material which is still not magnetized;
second step: setting said conducting magnet material into a mold;
third step: using a form material to produce a tip of tape measure structure via injection molding and making said form material to combine with said conducting magnet material;
fourth step: magnetizing said conducting magnet material and manufacturing a magnetic tip of tape measure.

26. A manufacturing method of magnetic tip of tape measure as claimed in claim 25, wherein the conducting magnet material is single metal or an alloy of at least two kinds of metals

27. A manufacturing method of magnetic tip of tape measure as claimed in claim 25, wherein first step which is preparing at least two conducting magnet material.

28. A manufacturing method of magnetic tip of tape measure as claimed in claim 25, wherein the conducting magnet material could be rectangle, circular, triangle or any shape.

29. A manufacturing method of magnetic tip of tape measure as claimed in claim 25, wherein a first and second portions of the conducting magnet material are exposed from the form material.

30. A manufacturing method of magnetic tip of tape measure as claimed in claim 29, wherein the first and second portions of the conducting magnet material respectively flush with a first and second sides of the form material.

31. A manufacturing method of magnetic tip of tape measure as claimed in claim 29, wherein the first and second portions of the conducting magnet material respectively protrude from with a first and second sides of the form material.

32. A manufacturing method of magnetic tip of tape measure as claimed in claim 25, wherein the form material is plastic material.

33. A manufacturing method of magnetic tip of tape measure comprising:
first step: preparing a magnetized conducting magnet material;
second step: setting said conducting magnet material into a mold;
third step: using a form material to produce a tip of tape measure structure via thixomolding and making said form material to combine with said conducting magnet material for manufacturing a magnetic tip of tape measure.

34. A manufacturing method of magnetic tip of tape measure as claimed in claim 33, wherein the conducting magnet material is single metal or an alloy of at least two kinds of metals

35. A manufacturing method of magnetic tip of tape measure as claimed in claim 33, wherein first step which is preparing at least two conducting magnet material.

36. A manufacturing method of magnetic tip of tape measure as claimed in claim 33, wherein the conducting magnet material could be rectangle, circular, triangle or any shape.

37. A manufacturing method of magnetic tip of tape measure as claimed in claim 33, wherein a first and second portions of the conducting magnet material are exposed from the form material.

38. A manufacturing method of magnetic tip of tape measure as claimed in claim 37, wherein the first and second portions of the conducting magnet material respectively flush with a first and second sides of the form material.

39. A manufacturing method of magnetic tip of tape measure as claimed in claim 37, wherein the first and second portions of the conducting magnet material respectively protrude from with a first and second sides of the form material.

40. A manufacturing method of magnetic tip of tape measure as claimed in claim 33, wherein the form material is magnesium alloy.

41. A manufacturing method of magnetic tip of tape measure comprising:
first step: preparing a conducting magnet material which is still not magnetized;
second step: setting said conducting magnet material into a mold;
third step: using a form material to produce a tip of tape measure structure via thixomolding and making said form material to combine with said conducting magnet material;
fourth step: magnetizing said conducting magnet material and manufacturing a magnetic tip of tape measure.

42. A manufacturing method of magnetic tip of tape measure as claimed in claim 41, wherein the conducting magnet material is single metal or an alloy of at least two kinds of metals

43. A manufacturing method of magnetic tip of tape measure as claimed in claim 41, wherein first step which is preparing at least two conducting magnet material.

44. A manufacturing method of magnetic tip of tape measure as claimed in claim 41, wherein the conducting magnet material could be rectangle, circular, triangle or any shape.

45. A manufacturing method of magnetic tip of tape measure as claimed in claim 41, wherein a first and second portions of the conducting magnet material are exposed from the form material.

46. A manufacturing method of magnetic tip of tape measure as claimed in claim 45, wherein the first and second portions of the conducting magnet material respectively flush with a first and second sides of the form material.

47. A manufacturing method of magnetic tip of tape measure as claimed in claim 45, wherein the first and second portions of the conducting magnet material respectively protrude from with a first and second sides of the form material.

48. A manufacturing method of magnetic tip of tape measure as claimed in claim 41, wherein the form material is magnesium alloy.
